(19) United States
(12) Patent Application Publication
(10) Pub. No.: US 2026/0010905 A1
(43) Pub. Date: Jan. 8, 2026

(54) POINT-OF-SALE (POS) SYSTEM FOR REAL-TIME FIAT TRANSACTION ROUTING AND SETTLEMENT VIA BLOCKCHAIN LEDGER WITHOUT CRYPTOCURRENCY CONVERSION

(71) Applicant: Orbix LLC, DEARBORN HEIGHTS, MI (US)

(72) Inventors: Mohamad Hamade, Dearborn, MI (US); Smantha Bevins, Canton, MI (US)

(21) Appl. No.: 19/323,270

(22) Filed: Sep. 9, 2025

Related U.S. Application Data
(63) Continuation-in-part of application No. 18/308,059, filed on Apr. 27, 2023.

(51) Int. Cl. G06Q 20/40; G06Q 20/36; H04L 9/00

(52) U.S. Cl. CPC G06Q 20/40145; G06Q 20/36; H04L 9/50

(57) ABSTRACT

A point-of-sale (POS) transaction routing system and method for real-time electronic fiat currency payments without cryptocurrency conversion includes a POS interface with biometric scanner for receiving fiat instruments (credit/debit card, ACH, wire) and capturing fraud-preventive data; an API/middleware for routing transactions across blockchain for on-chain validation; a payment gateway for hashing and recording metadata on the ledger; and a smart contract-based settlement mechanism delivering fiat to merchant wallets in sub-seconds. The blockchain serves as a low-latency validation/settlement layer, integrating biometrics for security, bypassing traditional delays without crypto exchange, and minimizing batch processing delays through real-time, individual transaction routing.

### CROSS-REFERENCE TO RELATED APPLICATION

This application is a continuation-in-part of co-pending U.S. patent application Ser. No. 18/308,059, filed on Apr. 27, 2023, titled “POINT-OF-SALE (POS) SYSTEM FOR AUTOMATICALLY CONVERTING TRANSACTIONS INTO CRYPTOCURRENCY,” the entirety of which is incorporated herein by reference.

### FIELD OF THE INVENTION

The present invention relates to a point-of-sale (POS) system and method for routing and settling fiat currency transactions in real-time using a blockchain ledger as a validation and settlement layer, without converting funds to cryptocurrency or relying on traditional intermediary networks like ACH or wire transfer systems that introduce delays.

### BACKGROUND OF THE INVENTION

Traditional payment processing at point-of-sale (POS) terminals relies on networks like credit/debit card processors, Automated Clearing House (ACH), or wire transfers, which often involve batch processing, intermediaries, and settlement delays of 1-5 business days. These systems are prone to fraud, high fees, and latency, particularly for cross-border or high-volume transactions.

Cryptocurrency-based systems, as disclosed in prior art such as U.S. Patent Publication No. US20190236561A1 (Hamilton), provide POS terminals for cryptocurrency transactions interacting with exchanges, but require conversion between fiat and crypto, exposing users to volatility and regulatory risks. Similarly, U.S. Patent No. U.S. Pat. No. 11,257,071 (Castinado) describes a closed-loop platform for dynamic currency conversion, bypassing traditional processing but still involving conversion risks and not leveraging blockchain for fiat-only settlement.

U.S. Pat. No. 10,055,715B1 enables virtual currency acceptance at POS but focuses on diversity of currencies with conversion, not fiat routing without exchange.

Other systems, like those in U.S. Patent Application Publication No. US20230325817A1 and U.S. Pat. No. 12,045,792, integrate crypto or virtual currencies into POS but do not address real-time fiat settlement via blockchain without conversion, nor do they incorporate hardware like biometric scanners for on-chain fraud validation.

These mechanisms fail to provide a secure, low-latency system for routing fiat transactions (e.g., credit/debit, ACH, wire) through blockchain for immutable validation and settlement, while keeping funds in their original fiat form. Merchants face integration challenges, as crypto exchanges differ from traditional gateways, and existing solutions often require one-to-one relationships or custom payment pages, without real-time settlement.

There is a need for a POS system that routes fiat transactions without conversion to reduce delays, fees, and fraud through technical integrations and improvements such as smart contracts and biometric hardware.

### SUMMARY OF THE INVENTION

A point-of-sale (POS) transaction routing system for electronic fiat currency payments includes: a POS interface configured to receive a fiat-based payment instrument input from a customer, wherein the fiat-based payment instrument is a credit card, debit card, Automated Clearing House (ACH) instruction, or wire transfer; an application programming interface (API) or middleware layer operatively coupled to the POS interface and configured to route the fiat transaction across a blockchain network in real-time for on-chain validation without converting the fiat currency to cryptocurrency; a payment gateway configured to monitor the transaction and record hashed transaction metadata on the blockchain ledger for immutable fraud detection; and a settlement mechanism configured to ensure final delivery of the fiat value to a merchant wallet, custodial or non-custodial, wherein the blockchain ledger serves as a real-time settlement and validation layer, bypassing traditional batch processing delays associated with ACH or wire networks.

The system provides a technical improvement by enabling sub-second settlement times through on-chain smart contract execution, hashing metadata (e.g., transaction ID, amount, timestamp) onto the blockchain for tamper-proof records, and integrating biometric hardware for real-time fraud prevention, all without cryptocurrency exposure. This minimizes batch processing delays normally associated with financial transactions by replacing periodic batch settlements with continuous, decentralized on-chain validation and settlement.

### BRIEF DESCRIPTION OF THE DRAWINGS

FIG. 1 illustrates a schematic diagram of the POS system architecture, including the POS interface, API/middleware, blockchain network, payment gateway, and merchant wallet.

FIG. 2 is a flowchart depicting the method for routing and settling a fiat transaction via blockchain.

FIG. 3 is another flowchart showing integration with biometric scanning and smart contract execution.

FIGS. 4a-4f are exemplary user interfaces displayed on a customer or merchant device during transaction processing, including payment selection (4a), biometric prompt (4b), routing confirmation (4c), on-chain validation (4d), settlement receipt (4e), and metadata hash view (4f).

### DETAILED DESCRIPTION OF THE INVENTION

Various embodiments of the invention will now be described with reference to the accompanying drawings. The terminology used herein is for the purpose of describing particular embodiments only and is not intended to be limiting.

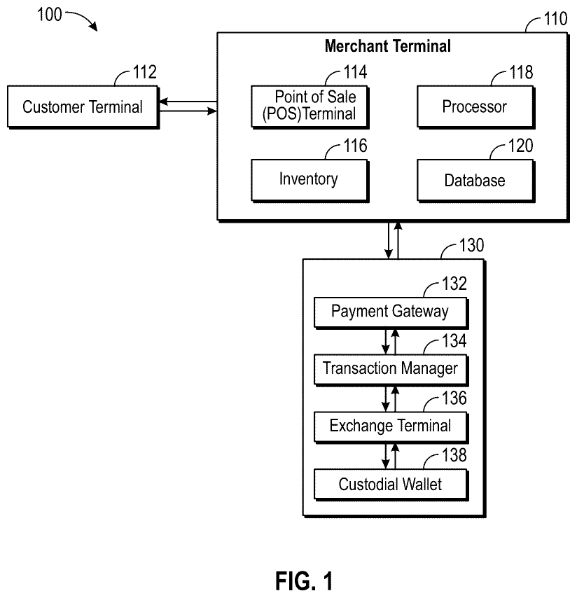

FIG. 1 is the POS system 100 including a POS interface 110 (e.g., touchscreen terminal with integrated card reader and biometric scanner), API/middleware 120 for blockchain routing, blockchain network 130 (e.g., Ethereum Layer 2 for low-gas fees), payment gateway 140 for metadata hashing, and merchant wallet 150 for fiat settlement.

Unless otherwise defined, all technical and scientific terms used herein have the same meaning as commonly understood by one of ordinary skill in the art to which this invention belongs. The terminology used in the description of the invention herein is for describing embodiments only and is not intended to be limiting of the invention. As used in the description of the invention and the appended claims, the singular forms “a”, “an” and “the” are intended to include the plural forms as well, unless the context clearly indicates otherwise.

The present invention will now be described more fully hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

Prior to a description with reference to the drawings, to help understanding of the present invention, terms used in this specification are described in brief.

As used herein the terms “customer,” “consumer,” and “user” may be used synonymously and interchangeably.

The term “Payment gateway” as used herein refers to a payment terminal that sits in between a customer and a merchant and ensures that funds are transferred securely and correctly when a transaction is performed.

The term “FX blockchain” as used herein refers to virtual/digital currencies/Cryptocurrencies i.e. Bitcoin which is a form of electronic money created from code using an encrypted string. Ownership of cryptocurrency is usually recorded in a cryptographically encrypted immutable sequence of data blocks called a blockchain. The cryptocurrencies allow owners to maintain anonymity and privacy because ownership is linked to a wallet address which is usually just a cryptographic public key.

The term “exchange terminal” is an exchange system for financial transactions on blockchain systems. It also provide means to trade cryptocurrencies with traditional currencies.

Throughout this description reference may be made toward specific currencies such as Bitcoin or the United States dollar (USD). Such references will be understood to be merely examples of other currencies. For example, references to Bitcoin should be understood to be interchangeable for any cryptocurrency, and particularly cryptocurrencies recorded on a blockchain. References to the United States dollar should be understood to be interchangeable for any fiat currency managed by a central authority, such a country (United States, Japan, Canada, China, etc.), a central bank, or a decentralized stable coin token or currency.

Specifically, the present technology permits a customer to pay in any currency, while permitting the merchant to receive FX on blockchain or cryptocurrency rather than traditional currencies. In this way, the technology provides benefits that remove barriers to transactions that might inhibit international commerce, or commerce with certain types of currency.

Additionally, the present technology, through the presence of a trusted payment service, can increase trust in transactions taking place in multiple currencies.

Such increased trust can also be an important benefit of the present technology when a customer/merchant to the transaction wishes to remain anonymous.

Additionally, the present technology allows merchants to receive transactions and by-pass traditional transaction processing.

FIG. 1 is a Point-of-Sale (PoS) system for automatically converting transactions into cryptocurrency according to an embodiment of the present invention. The system 100 may be implemented as software executing in an application program interface (API) 130 integrated at a merchant terminal 110 communicating with one another over a network. The merchant terminal 110 comprises a customer terminal 112, a Point-of-Sale (PoS) terminal 114, an inventory 116, a processor 118 and a database 120. The application program interface (API) 130 comprises a payment gateway 132, a transaction manager 134, an exchange terminal 136, and a custodial wallet 138. The various components are illustrated and the arrangement of the components is presented for purposes of illustration only. It is to be noted that other arrangements with more or less components are possible without departing from the scope of the invention.

The techniques, methods, and system presented herein and below for Point-of-Sale (PoS) system for automatically converting transactions into cryptocurrency can be implemented in whole or in part in one, all, or some combination of the components shown with the system 100. The techniques and methods are programmed as executable instructions in memory and/or non-transitory computer-readable storage media and processed on one or more processors associated with the various components.

The application program interface (API) 130 is for transaction processing, according to the embodiments of the present invention. The components of application program interface (API) 130 are programmed and reside within memory and/or a non-transitory computer-readable medium and execute on one or more processors of the devices of the merchant terminal 110.

The application program interface (API) 130 is configured to execute on the processor 118 as executable instructions that perform transactions for purposes of purchasing goods or services or conducting financial transactions.

Further the system 100 includes one or more computer-readable non-transitory storage media for settling a point of sale transaction between a customer and a merchant, wherein the customer transact via debit/credit card and the merchant receives in cryptocurrency, the media embodying software that is operable when executed to: determine, by a payment service in communication with a point of sale system of a merchant, that the merchant has selected to receive payment in the cryptocurrency in order to settle the point of sale transaction.

The system 100 may start by receiving a request from customers at customer terminal 112 on the merchant terminal 110, adding the shopping items from the inventory 116, initiating a payment request at the payment gateway 132. The payment request may comprise a request for the payment through debit/credit card to the merchant account, whereas the transaction amount is automatically transferred in the custodial wallet 138 of the merchant in the form of cryptocurrency as an equivalent of the paid amount.

It is a simple process. Just like any process with transacting debit and credit cards however the merchant will be able to receive cryptocurrency and/or tether without having to do anything on their end. There is a designated wallet address for the merchant to receive their funds. The system 100 may generate a wallet address representing the risk assessment for the payment request.

The application program interface (API) 130 is integrated to the merchant terminal 110 to select the amount to transfer the equivalent cryptocurrency amount to the custodial wallet 138.

The application program interface (API) 130 is enhanced with the transaction manager 134 for performing transactions. That is, rather than deploying a specialized cryptocurrency terminal as dedicated hardware, the transaction manager 134 permits transactions and establishes network connections and communicates directly with the exchange terminal 136 during transactions in real time.

Further, funds are maintained on merchant's custodial wallet 138. The merchant can choose to cash out their money directly to their federal or state institutions rather than waiting on payment processing companies. In this way, the system 100 of the present invention provides the amount in real time and eliminates the extra charges incurred by the payment processing companies as well as eliminates the processing delays as faced by the merchant.

In these embodiments, the system 100 may further authenticate the customer, and the merchant. So in the preferred embodiment, the transaction amount is automatically transferred to the custodian wallet 138 instead of merchant's bank account.

In one embodiment, the present invention provides its own exchange terminal 136, and the exchange terminal 136 will act as a bank, where as soon as a transaction happens, the transaction amount goes to the custodial wallet 138. Hence one advantage of the present invention is that the system 100 eliminates the processing delays caused in the existing art. In an alternate embodiment but not necessarily, the system 100 also provides an optional toggle tap to select the transactions amount to be transferred whether to the custodial wallet 138 or the bank account of the merchant.

Alternatively, the invention, the exchange terminal 136 as cryptocurrency exchange service is invoked for the custodial wallet 138, which trades the particular cryptocurrency stored in the wallet 138 of the merchant in different types of currencies.

The wallet 138 of the merchant can be integrated with a cryptocurrency tumbler to pool together source funds from multiple inputs for a random period and then splitting them back out to destination blockchain addresses. This preserves anonymity of the merchant's transactions with customers.

This example can be modified to suit needs of a POS system operator. In another embodiment, the smart contract can convert any cryptocurrency into a privacy token such as Monero™, revert the conversion, and send the cryptocurrency back to the holder at a fresh new cryptocurrency blockchain address.

It should be appreciated that one embodiment of the POS (point of sale) terminal 114 as envisioned herein includes a touchscreen monitor, a barcode scanner for scanning barcodes on retail goods, a cash drawer for holding cash, a magnetic stripe reader for reading magnetic strips, a chip reader, a receipt printer for printing a record of any transaction, and a display pole for displaying data to a customer standing at the POS terminal. The touchscreen monitor is capable of displaying a bar code for receiving digital payments from a handheld device such as a smart phone. These components are functionally integrated and controlled by a processor. The system 100 is connected via hardware to a communications network such as the internet. The coin mixer can be integrated in the form of software, firmware, hardware, or provided by a third party via an internet connection.

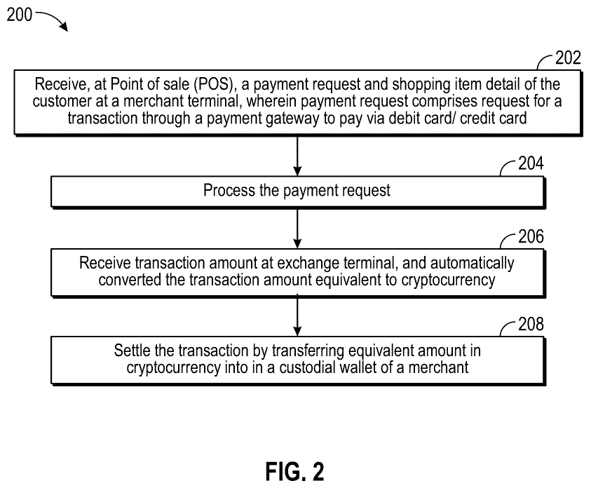

FIG. 2 shows an exemplary method 200 according to an embodiment of the present invention, where the method 200 starts at step 202 by receiving, at Point of sale (POS), a payment request and shopping item detail of the customer at the merchant terminal 110, wherein payment request comprises request for a transaction through a payment gateway to pay via debit card/credit card. Next, at step 204, start processing the payment request. At step 206, receive the transaction amount at the exchange terminal 136, and automatically convert the transaction amount equivalent to cryptocurrency. At step 208, the system 100 settles the transaction by transferring equivalent amount in cryptocurrency into the custodial wallet 138 of a merchant.

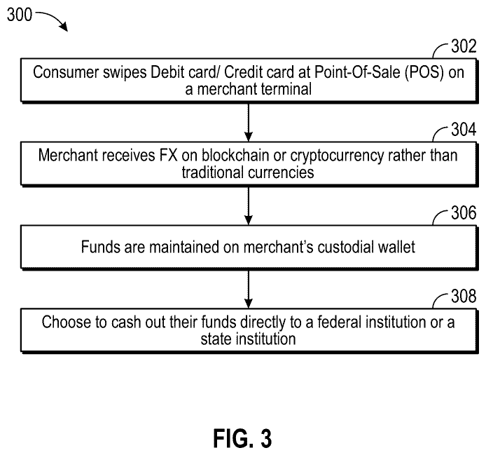

FIG. 3 shows another exemplary method 300 according to an embodiment of the present invention, where the method 300 starts at step 302 by receiving, at the payment gateway 132, a payment request and shopping basket details of a customer, where the customer swipes Debit card/Credit card at Point-Of-Sale (POS) on the merchant terminal 110. Next, at step 304 the Merchant receives FX on blockchain or cryptocurrency rather than traditional currencies. At step 306, Funds are maintained on merchant's custodial wallet 138. And at step 308, the merchant may choose to cash out their money directly to their federal institutions or state institutions rather than waiting on payment processing companies. For the cannabis industry, this is a solid loophole to deposit their funds into federal institutions through a crypto exchange/custodial wallet.

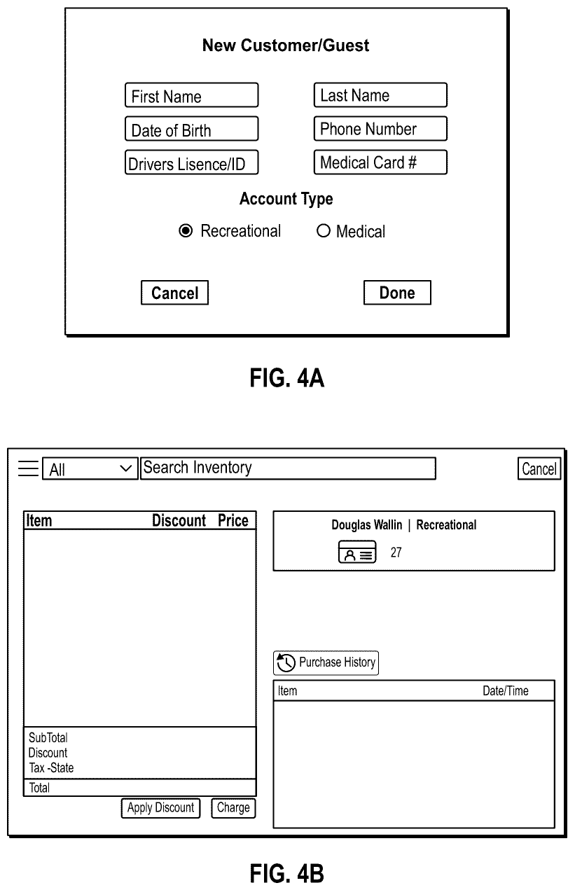

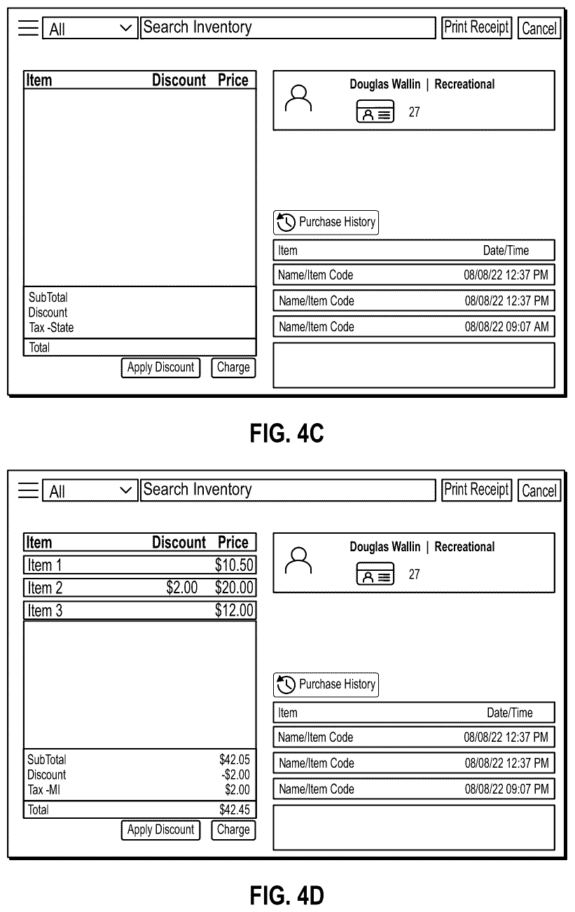

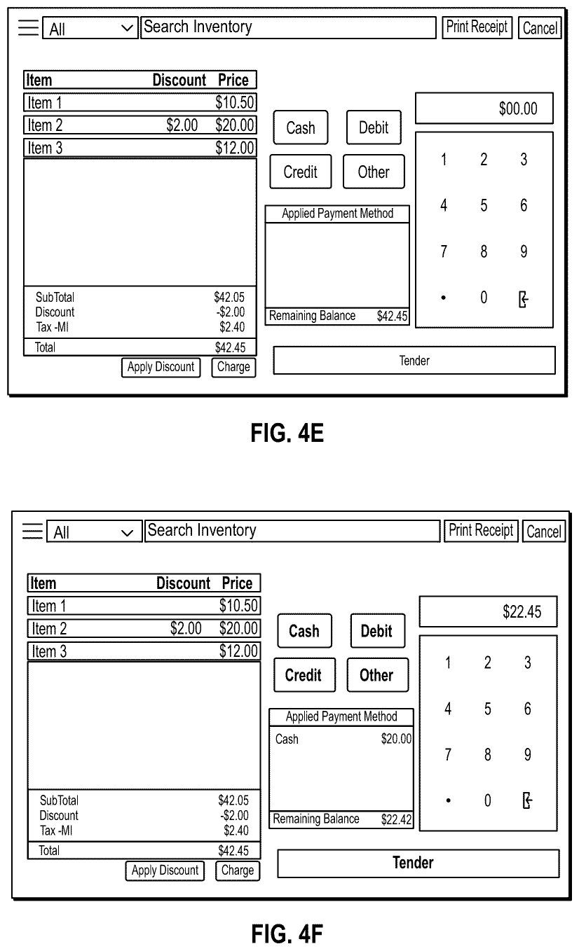

FIG. 4a shows a login/signup page for registration on the interface, where a customer enters the details before shopping. Once a customer is registered, the merchant landing page is displayed as shown in FIG. 4b. FIG. 4c shows the purchase history of the customer by means of scanning customer ID. FIG. 4d shows that the customer items are added along with the prices, which are performed by searching through the inventory. FIG. 4e shows the payment option through different modes of payments. FIG. 4f shows the total amount of the payment request, then the customer may make a transaction, and the transaction amount is automatically converted into cryptocurrency and the same is reflected in the custodial wallet 138 of the merchant. Where the merchant can choose to cash out their money directly to their federal or state institutions rather than waiting on payment processing companies.

Preferred System and Methods without Cryptocurrency Conversion

Preferred embodiments of the invention reference the accompanying drawings. The terminology used herein is for the purpose of describing embodiments only and is not intended to be limiting.

As shown in FIG. 1, the POS system 100 includes a POS interface 110 (e.g., touchscreen terminal with integrated card reader and biometric scanner), API/middleware 120 for blockchain routing, blockchain network 130 (e.g., Ethereum Layer 2 for low-gas fees), payment gateway 140 for metadata hashing, and merchant wallet 150 for fiat settlement.

The system preferably operates as follows: A customer presents a fiat instrument (e.g., debit card) at POS interface 110. The fiat instrument can also be cash, an application such as apple pay, a fingerprint, handprint or other biometric indicator. Future instruments that have not yet been invented may also be used.

The API 120 routes the transaction data, and metadata, to blockchain 130, where a smart contract validates it in real-time (e.g., via consensus mechanisms). Payment gateway 140 hashes metadata (e.g., using SHA-256) or other suitable algorithm, and records it on-chain for immutable audit trails. The data may include date, amount of fiat currency transacted, location, and select portions of the customer identity.

Settlement occurs directly to wallet 150 in fiat, bypassing ACH delays. The system, as described in the patent application, utilizes SHA-256 for generating cryptographic hashes of transaction metadata (e.g., transaction ID, amount, timestamp, and biometric data) to ensure immutability, integrity, and fraud detection when recording on the blockchain ledger.

SHA-256 is a widely used, secure hash function from the SHA-2 family, providing 128 bits of collision resistance and strong preimage resistance, making it suitable for financial and blockchain applications. It can be appreciated that numerous other algorithms can be used. These could replace SHA-256 while maintaining or improving security, speed, or other properties.

These alternatives should be cryptographic hash functions (collision-resistant, one-way, and deterministic) to preserve the system's requirements for tamper-proof records and on-chain validation without introducing vulnerabilities.

Below is a list of viable alternatives, categorized by family or type, with details on their strengths, differences from SHA-256, and suitability for the described system (e.g., real-time transaction hashing in a POS blockchain context). I focused on secure options recommended for modern cryptographic use, excluding deprecated ones like MD5 or SHA-1 due to known collision attacks.

SHA-512: Produces a 512-bit digest (twice SHA-256's 256 bits). It uses 64-bit words (vs. SHA-256's 32-bit), making it faster on 64-bit architectures (e.g., ˜5 cycles per byte vs. SHA-256's ˜7-8). Security: 256 bits collision resistance, no known attacks. Suitability: Excellent drop-in for the system if larger digests are acceptable; it could enhance performance in real-time routing on modern hardware without changing much code. Truncated versions like SHA-512/256 offer 256-bit output with higher security margins.

SHA-384 is a truncated SHA-512 with 384-bit output. Faster than SHA-256 on 64-bit systems (˜5 cycles per byte) it uses 192 bits collision resistance and is particularly good for systems needing intermediate digest sizes; resistant to length-extension attacks like SHA-256.

SHA-3 uses a sponge construction (Keccak), differing from SHA-2's structure, offering better resistance to certain attacks (e.g., length extension) and approved by NIST as alternatives to SHA-2.

SHA3-256 has a 256-bit output, like SHA-256. Although this is slower in software (˜8-9 cycles per byte) but excels in hardware (e.g., with ARM/Apple M-series instructions). In one embodiment, hardware such as ARM/Apple is used. It has 128 bits collision resistance and 256 bits preimage. This is ideal for blockchain systems (e.g., Ethereum uses Keccak-256) because it provides a direct replacement with enhanced theoretical security proofs and no reliance on SHA-2's potentially vulnerable design.

SHA3-512 has a 512-bit output. Its speed is similar to SHA3-256 but with higher security (256 bits collision) and is better for high-security metadata hashing; hardware acceleration makes it viable for real-time POS.

SHAKE256 (Extendable-Output Function or XOF) uses variable output (e.g., 256 bits) and it is faster than fixed SHA-3 variants (˜8 cycles per byte) due to lower security margins for some uses. It uses up to 256 bits preimage, but tunable, making it flexible for the system if variable-length hashes are needed (e.g., for biometric data). This is NIST-approved for non-fixed outputs.

BLAKE Family (Modern, High-Performance Alternatives) are based on ChaCha stream cipher, finalists in the SHA-3 competition, and emphasize speed without sacrificing security.

BLAKE2b has 512-bit output (or tunable). It is significantly faster than SHA-256 (˜3-5× in software, <5 cycles per byte) while matching security (no known attacks, immune to length extension). It is a strong alternative for performance-critical systems like POS; used in protocols like WireGuard and supports parallelism for large metadata.

BLAKE3 has variable output (e.g., 256 bits). Even faster (˜2-4×SHA-256, leveraging tree hashing for multi-core parallelism). Security: Equivalent to BLAKE2, with strong proofs. It is best for high throughput blockchain routing because it reduces sub-second settlement latency further. It can be used in modern apps for its efficiency on commodity grade hardware.

System Embodiments may include drop-in replacement (same 256-bit output, minimal code changes), using SHA3-256 or BLAKE3 (tuned to 256 bits). Performance gains and be achieved by using BLAKE3 or BLAKE2b, especially on multi-core systems for real-time hashing.

For higher security/hardware optimization, the system is adapted to use SHA-512 or SHA3-512 depending on implementation specifics (e.g., via libraries like OpenSSL) and test for collisions/preimage resistance in the context of fiat transaction metadata. If the system evolves to need variable outputs, SHAKE256 or BLAKE3's XOF mode is useful.

In another embodiment using enable real-time processing and minimizing batch processing delays normally associated with financial transactions (e.g., ACH batching every 1-2 days), the API includes pseudocode for routing:

| | |
|---|---|
| i. | function routeFiatTransaction(txData) { |
| ii. | // Hash metadata for on-chain record |
| iii. | let metadataHash = sha256(txData.id + txData.amount + |
| | txData.timestamp); |
| iv. | // Deploy to blockchain via Web3.js |
| v. | let contract = new web3.eth.Contract(ABI, address); |
| vi. | contract.methods.validateAndSettle(metadataHash, |
| | txData.amount).send({from: sender}); |
| vii. | // Settle to wallet without conversion or batch delay |
| viii. | transferFiatToWallet(txData.amount, merchantAddress); |
| ix. | } |

This integration reduces settlement from days to seconds by avoiding batch aggregation, improves security via hashing, and avoids crypto volatility.

For fraud prevention, a biometric scanner (e.g., fingerprint) at POS interface 110 generates a hash compared on-chain via smart contract, preventing unauthorized transactions.

The combination of the biometric data and the system of the present invention using a smart contracts and hashed metadata enables verification of identity of the user and financial settlement in nearly real time processing of any transaction. This eliminates time lag between the interaction with a POS system and transferring funds during a transaction with a POS operator.

The system is not merely abstract but provides a specific technological solution to latency and fraud in fiat processing, as traditional ACH/wire systems are batch-based and conventional, while this uses blockchain as a novel ledger layer without known WURC equivalents for fiat-only routing. By routing individual transactions directly to the blockchain for immediate consensus-based validation and smart contract execution, the invention eliminates the need for periodic batch processing, enabling continuous settlement and minimizing delays inherent in centralized financial networks.

1. A point-of-sale (POS) transaction routing system for real-time electronic fiat currency payments without cryptocurrency conversion, comprising:
a POS interface including an integrated biometric scanner and configured to receive a fiat-based payment instrument input from a customer and capture biometric data for fraud prevention, wherein the fiat-based payment instrument is selected from a credit card, debit card, Automated Clearing House (ACH) instruction, or wire transfer;
an application programming interface (API) or middleware layer operatively coupled to the POS interface and configured to route transaction data associated with the fiat-based payment instrument across a blockchain network in real-time for on-chain validation, wherein the routing bypasses traditional batch processing networks and maintains the transaction in its original fiat denomination without converting to cryptocurrency;
a payment gateway configured to generate a cryptographic hash of transaction metadata including a transaction identifier, amount, timestamp, and the biometric data, and record the cryptographic hash on a blockchain ledger for immutable fraud detection and auditability;
a settlement mechanism configured to execute a smart contract on the blockchain network to validate the transaction based on the cryptographic hash and ensure final delivery of the fiat value to a merchant wallet, custodial or non-custodial, in sub-second time frames, thereby reducing settlement latency compared to traditional ACH or wire transfer systems; and
wherein the blockchain ledger functions exclusively as a real-time settlement and validation layer for the fiat transaction, integrating the biometric data into the on-chain validation to prevent unauthorized access without intermediary custody or cryptocurrency exchange.

2. The system of claim 1, wherein the API is configured for compatibility with third-party POS systems or standalone hardware, and the blockchain network is selected from Ethereum, Base, Solana, Polygon, or a custom Layer 2 solution to minimize gas fees during routing.

3. The system of claim 1, wherein the merchant wallet receives the fiat value in the original denomination directly from the settlement mechanism, and the smart contract automates fee deduction and routing based on predefined rules embedded in the contract code.

4. The system of claim 1, wherein the biometric scanner captures data selected from fingerprint, facial recognition, retinal scan, or palm scan, and the payment gateway integrates the biometric data into the cryptographic hash for on-chain comparison against stored user profiles to enable real-time fraud prevention.

5. A method for conducting real-time fiat-based transactions via a blockchain ledger without cryptocurrency conversion, comprising:
receiving, at a POS interface including an integrated biometric scanner, a fiat-based payment instrument input from a customer and capturing biometric data for fraud prevention, wherein the fiat-based payment instrument is selected from a credit card, debit card, Automated Clearing House (ACH) instruction, or wire transfer;
routing, via an application programming interface (API) or middleware layer operatively coupled to the POS interface, transaction data associated with the fiat-based payment instrument across a blockchain network in real-time for on-chain validation, wherein the routing bypasses traditional batch processing networks and maintains the transaction in its original fiat denomination without converting to cryptocurrency;
generating, via a payment gateway, a cryptographic hash of transaction metadata including a transaction identifier, amount, timestamp, and the biometric data;
recording the cryptographic hash on a blockchain ledger for immutable fraud detection and auditability;
executing, via a settlement mechanism, a smart contract on the blockchain network to validate the transaction based on the cryptographic hash and ensure final delivery of the fiat value to a merchant wallet, custodial or non-custodial, in sub-second time frames, thereby reducing settlement latency compared to traditional ACH or wire transfer systems; and
wherein the blockchain ledger functions exclusively as a real-time settlement and validation layer for the fiat transaction, integrating the biometric data into the on-chain validation to prevent unauthorized access without intermediary custody or cryptocurrency exchange.

6. The method of claim 5, wherein the API routes the transaction data to a blockchain network selected from Ethereum, Base, Solana, Polygon, or a custom Layer 2, and the smart contract automates fee deduction and routing based on predefined rules.

7. The method of claim 5, further comprising displaying, on a user interface, real-time status updates including biometric verification confirmation, on-chain validation results, and a digital receipt linked to the cryptographic hash for post-transaction audit.

8. A method for minimizing batch processing delays in financial transactions using a point-of-sale (POS) system with blockchain integration, comprising:
receiving, at a POS interface, a fiat-based payment instrument input from a customer, wherein the fiat-based payment instrument is selected from a credit card, debit card, Automated Clearing House (ACH) instruction, or wire transfer, and
wherein traditional processing of the fiat-based payment instrument involves batch aggregation and periodic settlement delays of at least one business day;
routing, via an application programming interface (API) or middleware layer, individual transaction data associated with the fiat-based payment instrument directly to a blockchain network for immediate on-chain validation, bypassing batch aggregation in centralized networks;
generating a cryptographic hash of transaction metadata including a transaction identifier, amount, and timestamp;
recording the cryptographic hash on a blockchain ledger to create an immutable record, enabling continuous validation without waiting for batch cycles;
executing a smart contract on the blockchain network to perform consensus-based validation of the transaction in real-time and initiate settlement of the fiat value to a merchant wallet without cryptocurrency conversion;
completing the settlement in sub-second time frames by leveraging the blockchain's decentralized consensus mechanism, thereby minimizing the batch processing delays normally associated with financial transactions in traditional ACH or wire transfer systems.

9. The method of claim 8, further comprising capturing biometric data at the POS interface and integrating a hash of the biometric data into the transaction metadata for on-chain fraud detection, wherein the smart contract compares the biometric hash against stored profiles during validation to further reduce risks without introducing additional delays.

10. The method of claim 8, wherein the API routes the transaction data to a Layer 2 blockchain solution to minimize gas fees and latency, and the method further comprises automating fee deduction within the smart contract to ensure settlement occurs without intermediary holds, achieving end-to-end processing times under one second compared to multi-day batch settlements in conventional systems.

11. The method of claim 10 further comprising:
selecting, via a payment gateway, a cryptographic hashing algorithm from a group consisting of SHA-512, SHA-384, SHA3-256, SHA3-512, SHAKE256, BLAKE2b, and BLAKE3, based on system performance requirements including processing speed, output size, and hardware optimization; and
the selected the cryptographic hashing algorithm enhances system efficiency by optimizing for real-time hashing on multi-core or 64-bit architectures.

12. The method of claim 11, wherein selecting the cryptographic hashing algorithm comprises choosing SHA-512 or SHA-384 for systems prioritizing speed on 64-bit architectures and higher collision resistance, with SHA-512 providing a 512-bit digest and SHA-384 providing a 384-bit digest, thereby improving performance in real-time routing without significant code modifications.

13. The method of claim 11, wherein selecting the cryptographic hashing algorithm comprises choosing SHA3-256 or SHA3-512 for enhanced resistance to length-extension attacks and hardware-accelerated environments, with SHA3-256 providing a 256-bit output as a direct replacement for baseline hashing and SHA3-512 offering 512-bit output for high-security metadata.

14. The method of claim 11, wherein selecting the cryptographic hashing algorithm comprises choosing SHAKE256 for variable-length outputs in systems requiring flexible hashing of biometric data, enabling tunable security margins while maintaining sub-second processing times.

15. The method of claim 11, wherein selecting the cryptographic hashing algorithm comprises choosing BLAKE2b or BLAKE3 for performance-critical applications, with BLAKE2b providing tunable 512-bit outputs and parallelism support, and BLAKE3 leveraging tree hashing for multi-core efficiency, thereby reducing latency in high-throughput blockchain routing and achieving faster real-time settlements compared to baseline algorithms.
